(19) United States
(12) Patent Application Publication
(10) Pub. No.: US 2009/0193352 A1
(43) Pub. Date: Jul. 30, 2009

(54) INTERFACE FOR ASSISTING IN THE CONSTRUCTION OF SEARCH QUERIES

(76) Inventor: Robert Stanley Bunn, Alamosa, CO (US)

Correspondence Address: ROBERT STANLEY BUNN, 1402 W. 11TH, # 6, ALAMOSA, CO, 81101, US

(21) Appl. No.: 12/020,537

(22) Filed: Jan. 26, 2008

(51) Int. Cl. G06F 3/048

(52) U.S. Cl. 715/780

(57) ABSTRACT

A method of assisting a user in their search of the internet or other network. The user selects content from a set of search results at which time a graphical interface is presented to the user. By interacting with the presented interface the user relays their intent regarding the selected content, which is then appended to their current search allowing a new set of results to be returned. The user may repeat this process as many times as may be necessary.

### FIELD OF THE INVENTION

This invention relates to searching electronic databases whether the information being sought is contained within the Internet or on another computer network.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosures as they appear in the Patent and Trademark Office patent files or records, but otherwise reserves all copyright and trade dress rights whatsoever.

### BACKGROUND

Internet search engines are designed to locate desired information from among the vast amount of information contained across the Internet. Users describe the information they are looking for by entering queries containing search terms. The search engine matches the search terms against an index of Web pages using a variety of relevance calculations with the objective of identifying those Web pages that are most likely related to the information sought by the users. The search engine then returns a ranked list of hyperlinks to these Web pages, with the links determined to be most relevant nearer the top of the list. This basic process is shown in FIG. 2. In order to use a search engine, each user must figure out for themselves how to construct and enter a query that will cause the search engine to return a results list containing links to sources that will most likely provide the information the user is seeking. Traditionally, searching was done by search experts who were skilled at crafting elaborate and precise Boolean queries. This is a skill that is still in common use at places such as news organizations, libraries and the United States Patent Office. However, on the Internet, most users are unfamiliar with such techniques, and usually enter no more than a few words, with no particular logical expression, hoping the search engine will provide the information they are seeking.

Most search engines today have as an objective of their user interaction design to provide relevant search results without requiring precise queries, by factoring in other evidence about relevance. For example, search engines may analyze the hyperlinks between Web pages, or look for documents that contain terms that are semantically similar to the terms in the query, or demonstrate a high level of co-occurrence with terms in the query over the corpus of documents.

Results returned by search engines can also be manipulated. Web site owners can add content or meta data or hyperlinks from other Web sites to their Web site, so that their Web pages are listed near the top of results lists, even though the Web pages do not contain information that is highly related to a user's query. This practice is often referred to as Search Engine Optimization (“SEO”).

Because search techniques have limits and because search engines cannot divine the intent of users in conducting searches, users are often unsatisfied or frustrated with the results returned by search engines. If the user happens to construct a query that yields satisfactory results, there is no mechanism by which he can share that query with other users who wish to do the same or a similar search. Likewise, there is no mechanism for users to review input from others as they attempt to construct queries that will cause the search engine to return the desired results. Search engines do not allow users to learn from one another, or to take advantage of successful searches conducted by one another. The objective of search engines is not simply to provide lists of links to documents, but ultimately to provide access to the most relevant information to users in response to their queries. Conventional search engines provide primarily a ranked list of hyperlinks to Web pages that are determined by computer algorithms to be relevant. Users looking for answers to questions about a subject area must follow those hyperlinks and search around on those Web sites for the information they are seeking. Search engines do not return information about the subject, or direct answers to questions in addition to links to Web sites.

Additionally, search engines have a difficult time disambiguating between different concepts that can be described by the same query term. For example the query “star wars” may refer both to the movie “Star Wars” and to the Strategic Defense Initiative. Attempts have been made to develop algorithms such as clustering or semantic analysis in order to determine which concept a user is searching for when he enters a query, but so far with limited success. Often users have knowledge of the concept to which their query pertains. It would be advantageous if those users were able to enter this relevant information to help the search engine disambiguate between that concept and other related concepts. This information would also help other users to understand the concept and assist in the process of searching for information about the concept.

### Terminology

Throughout the following description and claims, the term “search engine” refers to an apparatus (or programs running on general purpose computers) that take as input a query and return a results list of hyperlinks to electronic documents or Web pages. The search engine includes the index of documents in its corpus, the code and algorithms that determine the relevance of each document, and the graphical user interface that delivers the results list to the user.

Throughout the following description and claims the term “database” refers to any system that can store information which allows that information to be searched.

Throughout the following description and claims the terms “query” or “search query” refer to a set of terms submitted to the search engine whether typed, spoken, submitted through a “link” that already has embedded a set of search terms, or submitted by any other interface. A query (or search query) can comprise a single word, multiple words, a string of characters, or phrases. The query can be phrased as a question (e.g., a “natural language” query), a loose set of terms, or a structured Boolean expression. Indeed, a query (or search query) can comprise symbols or any other characters used by a search engine to search for electronic documents or Web pages containing or related to the search characters.

Throughout the following description and claims the term “web browser” refers to any computer application allowing the user to view any content within the Internet, intranet, or other network system. The term “Internet browser” is synonymous with “web browser” in this document.

Throughout the following description and claims, the terms “Web site” or “website” refer to a collection of Web pages that are linked together and are available on the World Wide Web or Internet.

Throughout the following description and claims, the term “Web page” refers to a publication accessible over the World Wide Web (or Internet) from any number of hosts and includes, but is not limited to, text, video, images, music, and graphics.

Throughout the following description and claims, the term “results list” or “result list” refers to a list of hyperlinks that reference documents or Web Pages that are accessible using the Hypertext Transfer Protocol (HTTP) or any other protocol for accessing Web pages or other electronic documents, along with other associated information for each link, including, but not limited to, titles of the documents, summaries of the documents, links to cached copies of the documents, the date on which the documents were last indexed or last modified, images associated with or located within the documents, and information extracted from the documents.

Throughout the following description and claims, the term “word” in addition to its ordinary meanings is given the meaning of a group of text characters in a document separated by a space or any other possible way to delineate separate words.

Throughout the following description and claims, the term “phrase” in addition to its ordinary meanings is given the meaning of a group of words in a document.

Throughout the following description and claims, the term “document” is defined broadly, and includes, in addition to its ordinary meaning, computer files and Web pages whether those pages are actually stored or are generated dynamically in response to a request to display. The term “document” is not limited to computer files containing text, but also includes computer files containing graphics, audio, video, and other multimedia data.

### BRIEF DESCRIPTION OF THE DRAWINGS

The appended claims set forth the features of the invention with particularity. The invention is illustrated by way of example, and not by way of limitation, from the following detailed description taken in conjunction with the accompanying drawings of which:

FIG. 1 is a block diagram of one possible architecture of a client/search engine relationship.

FIG. 2 is a flow diagram of a prior art method of a search engine user to obtain a set of search results from the submitted search query.

FIG. 3 is a flow diagram of an exemplary process of this invention as may be utilized in embodiments of the invention.

FIG. 4 is an exemplary illustration of the client computer 105 shown in FIG. 1

FIG. 5 is an exemplary illustration of another possible interface for the search engine user to interact with to specify their intent relating to the content selected or to the search query itself. This interface is designed to allow the user to construct a search query designed to add or remove content relating to a category of information instead of specific content.

FIG. 6 is an exemplary illustration of how an exemplary interface may be displayed for the user on an exemplary search engine.

FIG. 7 is a block diagram of an exemplary computer system as may be utilized in embodiments of the invention.

### DETAILED DESCRIPTION OF THE PREFERRED EMBODIMENT

The embodiments of the present invention are not limited to a single computing environment. Moreover, the architecture and functionality of the embodiments of the present invention as taught herein and as would be understood by one skilled in the art is extensible to other types of computing environments and embodiments in keeping with the scope and spirit of the embodiments of the present invention. The embodiments of the present invention provide for various methods, computer-readable mediums containing computer-executable instructions, and apparatus. With this in mind, the embodiments discussed should not be taken as limiting the scope of the embodiments of the present invention; rather, the embodiments of the present invention contemplate possible embodiments as may come within the scope of the appended claims.

The embodiments of the present invention include various operations, which will be described below. The operations, may be performed by hard-wired hardware, or may be embodied in machine-executable instructions that may be used to cause a general purpose or special purpose processor, or logic circuits programmed with the instructions to perform the operations. Alternatively, the operations may be performed by any combination of hard-wired hardware, and software driven hardware.

The embodiments of the present invention may be provided as a computer program product that may include machine-readable medium, stored thereon instructions, which may be used to program a computer (or other programmable device) to perform a series of operations according to the embodiments of the present invention. The machine-readable medium may include, but is not limited to, floppy diskettes, optical disks, CD-ROMs, DVDs, magno-optical disks, ROMs, RAMs, EPROMs, EEPROMs, hard drives, magnetic or optical cards, flash memory, or any other medium suitable for storing electronic instructions. Moreover, the embodiments of the present invention may also be downloaded as a computer software product, wherein the software may be transferred from a remote computer to a requesting computer by way of data signals embodied in a carrier wave or other propagation medium via a communication link (e.g. a modem or a network connection).

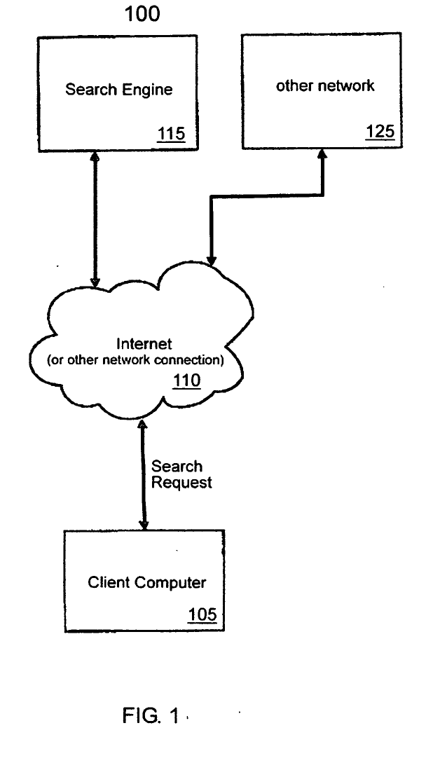

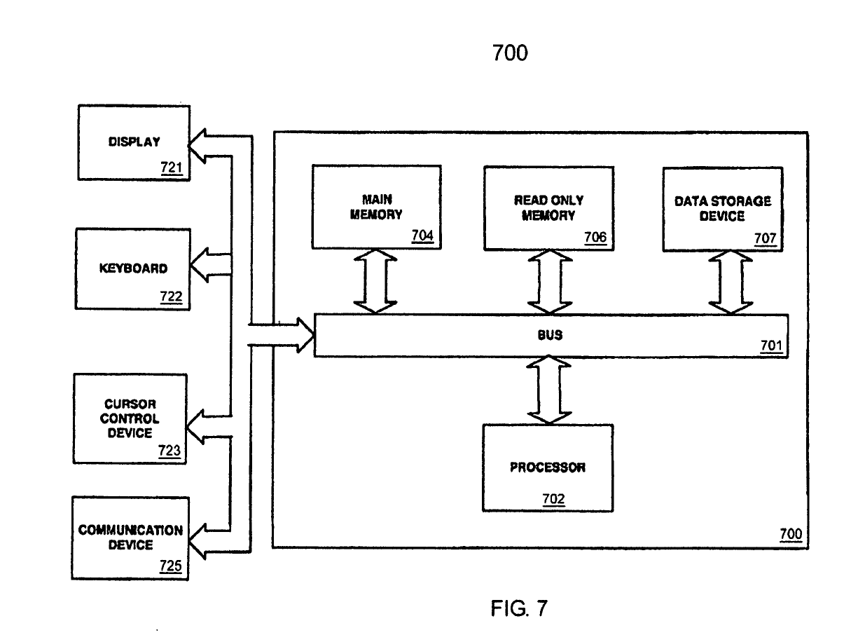

FIG. 1 illustrates an exemplary architecture 100 for the embodiments of the present invention. A client computer 105 is coupled to the internet, an intranet or some other network via a network connection such as but not limited to a modem, a cable modem, or an Ethernet connection. Typically the client 105 will be running a software application designed for communication over the network. In the exemplary embodiment, that software application would typically be a web browser such as Microsoft Internet Explorer or Mozilla Firefox that allows the client to receive and render HTML documents on its display 721 (FIG. 7). Alternative embodiments may employ different software applications to facilitate network communication or in certain instances a special software application may not be required, and the requisite code to initiate an interactive search query refinement session may be resident in a client's operating system.

Also coupled to the Internet, Intranet, or other network via a network connection is a search engine 115. The primary function of a search engine 115 is to return a relevant list of search results to a client 105 after a search query has been entered and submitted by the client 105. More specifically, the web browser on the client computer 105 would be responsible for transmitting the client's request to the search engine 115.

In general, the routines executed to implement the embodiments of the present invention, whether implemented as part of an operating system or a specific application, component, program, object, module or sequence of instructions, or even a subset thereof, will be referred to herein as “computer program code,” “program code,” “javascript code,” or simply “code.” Program code typically comprises one or more instructions that are resident at various times in various memory and storage devices in a computer, and that, when read and executed by one or more processors in a computer, cause that computer to perform the operations necessary to execute operations or elements embodying the various aspects of the embodiments of the present invention. Moreover, while the embodiments of the present invention are and hereinafter will be described in the context of fully functioning computers and computer systems, those skilled in the art will appreciate that the various embodiments of the present invention are capable of being distributed as a program product in a variety of forms, and that the embodiments of the present invention applies equally regardless of the particular type of computer readable media used to actually carry out the distribution. The computer readable media may include, but is not limited to, transmission type media such as digital and analog communication links.

In addition, various program code described hereinafter may be identified based upon the application within which it is implemented in a specific embodiment of the present invention. However, it should be appreciated that any particular program nomenclature that follows is used merely for convenience, and thus the embodiments of the present invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the present invention are not limited to the specific organization and allocation of program functionality described herein.

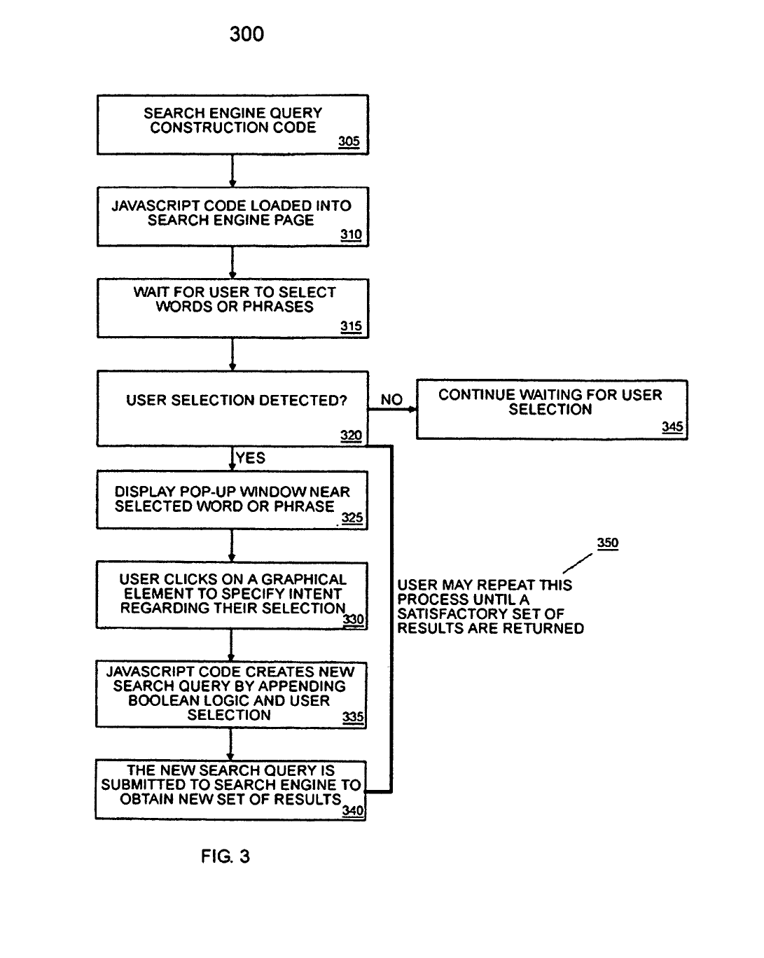

In the implementation illustrated in FIGS. 3-6, search query refinement on-demand is implemented in a browser, e.g., using a plug-in 410 containing the program code 305 in a conventional browser 415 to permit the use of the embodiments of the present invention. Those skilled in the art will recognize, however, that the exemplary environment illustrated in FIG. 7 is not intended to limit the embodiments of the present invention. Indeed, those skilled in the art will recognize that other alternative hardware and/or software environments may be used without departing from the scope of the present invention. For example, on-demand search query refinement functionality may be integrated into the program code for a browser, or into another application that displays documents other than web pages. On-demand search query refinement functionality may also be implemented within an operating system. Furthermore, on-demand search query refinement may be performed in a distributed manner, e.g., using a central server to perform some of the functionality associated with on-demand search query refinement.

The embodiments of the present invention comprise systems and processes for receiving inputs from users of search engines and converting these inputs into a modified search query based on the original user-entered search query. The user device is one of a personal computer, a portable phone, and a personal digital assistant, or any other device that is configured to communicate with a web server on the Internet or any other computer network.

In variations of embodiments of the present invention the modified search query may be submitted automatically after each user input, or the submission can be directed by the user after some combination of inputs. Inputs may be in any form of communication possible between a user and the computer. These forms of communication include, but are not limited to, keyboard, mouse, and speech.

An embodiment of the present invention allows a user to select words or phrases to cause the appearance of a graphical user interface. This user interface is made interactive by embodiments of the present invention to allow the user to specify their intent in relation to the selected words or phrases. An embodiment of the present invention automates the process of constructing and resubmitting a Boolean search query likely to be based on the current search query. It is not necessary for a user to understand anything about Boolean search queries in order to use the embodiments of the present invention.

An initial search is made on an Internet (or other computer network) search engine which creates a starting point for the user to continue to refine the search using the embodiments of the present invention. After this starting point has been created then the user may select specific words or phrases in the list of search results generated by a previous search. This embodiment of the present invention allows the user to click on (for example, with a mouse) or choose by any other means specific words or phrases in the results list. After this choice has been made the user is then presented with a small graphical interface which contains two images of buttons, one containing the image of a “+” symbol and the other an image of a “−” symbol. As these symbols are somewhat language neutral, it saves the effort of translating words describing the meaning of these symbols into various languages. The user clicks on the a “+” button if he/she desires more results relevant to or containing the chosen word or phrase, and clicking on the “−” button will result in limiting results relevant to or containing the chosen word or phrase in the newly returned search results. After selecting either button the chosen word or phrase is automatically appended to the current search query along with any necessary symbols to convey the users' intent to the search engine using Boolean logic typically employed by search engines. After adding to the search query the results are refreshed for the user automatically at which point the user may repeat this process until the desired search results are obtained. A specific example of how these symbols refine the search query follows. If the user had an initial search query of “star”, then after reviewing their set of results from this initial search the user then decided that they did not want results relating to the word “celebrity” which they had found in the content of their results list. The user would then select the word “celebrity” by highlighting or perhaps double-clicking on it (possibly with a mouse). The user would then see the pop-up window appear near to the selection they just made, at which point the user can choose the “+” or “−” symbols to specify intent. In this specific example the user would select the “−” symbol. Upon selecting the “−” symbol the program code would create the following example search query to send to the search engine “star-celebrity”. This refined search query would also be automatically sent to the search engine immediately after constructing the new query. The user will then be presented with a new set of results similar to the previous except for the removal of results related to the word “celebrity”.

Embodiments consistent with the invention typically implement on-demand search query refinement in response to detecting the selection of content by the user, typically using manipulated pointer (e.g., via user manipulation of a GUI pointer via a mouse, touchpad, track ball, cursor key, touch screen input, gesture, voice or other suitable user input) over a region in a document containing content a user may want to select.

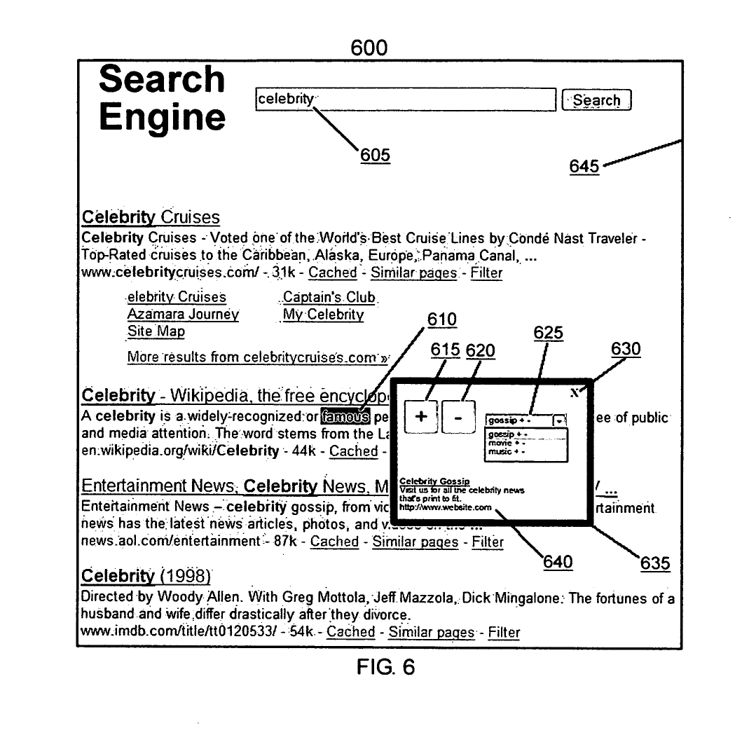

In one embodiment of the invention, the display of the user interface 635 is implemented within a pop-up window, e.g., a dialog box, a tool tip, a “bubble” or other suitable graphical control, and typically adjacent to or proximate to the pointer. FIG. 6, for example, illustrates an exemplary browser window 600 for a browser utilizing a search query refinement plug-in incorporating on demand search query refinement functionality. Window 600 is shown displaying a web page 645 after the user has already performed a search using the search query of “celebrity.”

Web page 645 includes a highlighted region 610 within which is displayed the content selected by the user, in this example the selected content is the word “famous.”

FIG. 6 also illustrates a second region 625 which is shown in this example as a drop-down list box from which the user can select from a list of possible words or phrases the user may want to use in the refinement of the current search query, and a third region 640 which shows an area on the user interface 635 which allows for displaying advertisements or alternate hyperlinks of any kind to the user. It will be appreciated that, for example, if the current search query is the word “celebrity,” then the area 640 may show advertisements or other hyperlinks related to the search query “celebrity.” In this regard, it may be desirable in some instances to determine the advertisements or other hyperlinks shown to the user based on a stored user profile to possibly increase the relevance to the user.

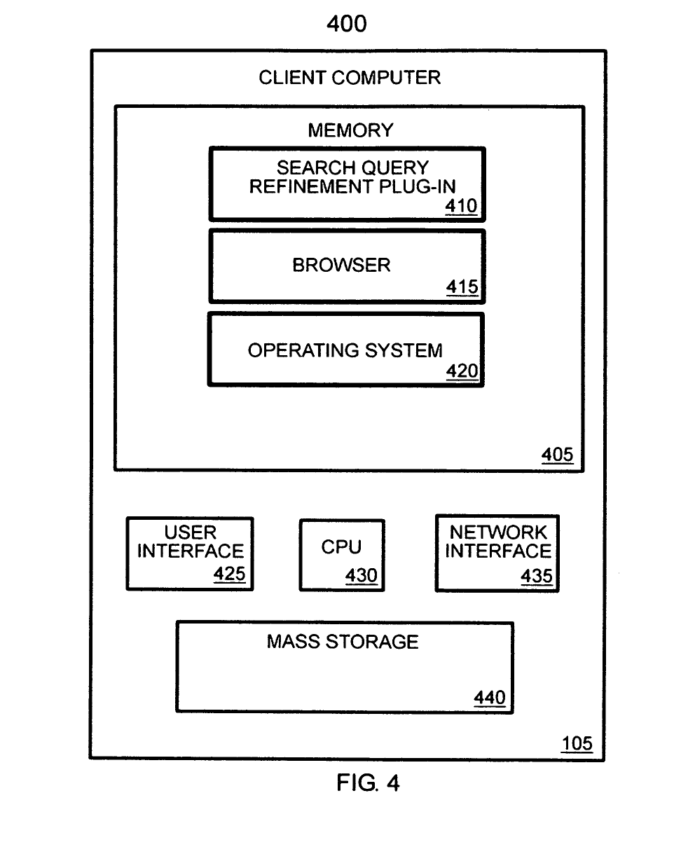

FIG. 3 illustrates one exemplary implementation of a search query refinement routine 300 executed by the illustrated search refinement plug-in 410 (FIG. 4). It will be appreciated that routine 300 need not be implemented in a plug-in, but may be implemented in any suitable program code capable of being executed on a user computer.

Routine 300 begins in block 310 by injecting the program code into the search engine page which is typically done locally, but could also be done remotely if the program code is stored on a server. Next, block 310 waits on the user to make a selection of content. Typically the user would do this by double-clicking on a word on the page if using a mouse, or highlighting on a word or phrase. It should be appreciated that many other cursor control devices could provide the user the ability to make a selection as well. If a user selection is detected, block 320 passes control to block 325. Otherwise, control remains at block 320 to continue to wait on the user to make a selection. Block 345 simply clarifies that control remains at block 320 if no user selection has been made.

If a user selection is detected, block 325 determines whether a pop-up window is already displayed. Assuming that no window is currently displayed, the program code will then cause one to be displayed.

Block 330 waits for a user to make a selection of either the “+” or the “−” button to specify their intent in relation to the selected content. Block 335 then executes the proper code to refine the current search query depending if the user selected the “+” or the “−” symbol. Block 340 then automatically submits this newly built search query to the search engine to return a new set of results to the user. Once this new set of results has been returned then control will return to block 315 so the user may repeat this process as many times as desired as shown in element 350.

It will be appreciated that user selection may be detected in a number of manners consistent with the invention. For example, routine 300 may monitor for events relating to a user selection such as mouseover, mouseenter, mouseout, mousemove events. In addition, it will be appreciated that the region searched upon detecting pointer movement may vary in different embodiments of the present invention. The region may be based, for example, upon a certain distance from the pointer position, upon the graphical object over which the pointer is positioned, upon a number of words in either direction of the current text over which the pointer is positioned, etc. In addition, it will be appreciated that rather than requiring a user to explicitly select content they may desire to use in their search refinement, some embodiments of the present invention may further automatically execute program code based on the position of the cursor, e.g., the cursor may move over content already determined to be a likely candidate to use in a search refinement. The program code may also help the user find content that may be particularly helpful in refining a search by explicitly identifying such content to the user, e.g., specific words or phrases may already be highlighted or in some other way distinguished from the rest of the content. It should also be appreciated that the pop-up window may be placed multiple times on a search page for the convenience of the user. In addition it should also be appreciated that the size, shape, and content of the pop-up window may change as may be decided by the user and/or program code. For example, small elements containing “+” and “−” symbols may be placed with each set of highlighted content which would not require the user to take any explicit action to enable or use. The user may simply interact with elements already placed within, or even outside of the content for their use if desired. It should also be noted that the user may still choose to edit their search query by hand if the search query built by the embodiments of the present invention is determined to be unsatisfactory by the user. In addition, the program code may identify specific results in the results list which were not present in the previous search, or previous searches, to assist the user in identifying new content with each search refinement action.

Routine 300, it should be noted, performs both refinement of the current search query and the automatic submission of this newly constructed search query, on-demand, and in response to user selection or cursor movement over a region including appropriate content. In other embodiments, however, search query refinement suggestions may be performed prior to, and thus, non-responsive to user selection of content.

### Other Embodiments and Other Variations

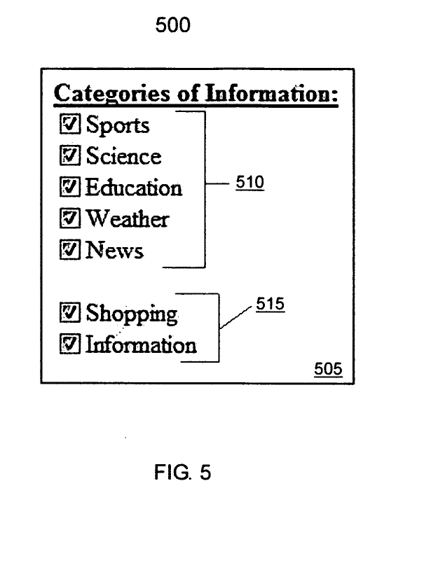

Another possible embodiment of the present invention is to offer the user a selection of pre-built search queries based on general categories of information as shown in element 510 (FIG. 5). These pre-built search queries contain text and any necessary Boolean logic to return or filter results from a generic category of information such as education or science before it is resubmitted to the search engine. This allows a user to simply select a specific category of information that is desired or undesired after making an initial search. A specific example might be that a user has made an initial search for the word “star”. As the word star has common meanings in relation to entertainment “movie stars,” and also in relation to the celestial bodies. If the user chooses to use the pre-built query for removing content related to the general topic of “science”, then this pre-built query will be appended to the users' original query returning a result set removing results related to celestial bodies as a scientific topic.

As a variation of the preceding embodiment, users of the Internet commonly have one of two goals when making a search. Either they are looking to make a purchase or they are simply looking for information. By creating two pre-built search queries, one for making purchases and one for information, a user can choose either category to limit content based on a financial related intent. This is shown in element 515 (FIG. 5).

Another embodiment of the present invention involves showing the user potentially useful terms to refine their current search with as shown in element 625 (FIG. 6). The user may select from a list of pre-built search queries which the embodiments of the present invention would use to refine the users' present search query.

Another embodiment of the present invention involves any combination of any described embodiments of the present invention and the addition of advertising or informational links in the graphical interface as shown in element 640 (FIG. 6). The user may choose one of these alternative links as opposed to the links in the results list. The advertising or informational links may be dynamically generated relating to the current search query, or they may be pre-determined unrelated to the users' searches. It should be noted that typically a user will have their attention focused on the area of the page where they are selecting specific content, this situation may cause the advertisements or hyperlinks contained in the pop-up window to be selected more often than other advertisements or hyperlinks present elsewhere on the results list page.

As a variation of the preceding embodiment of the present invention the user may be offered the choice of various alternative search engines to have a set of results returned from the chosen search engine likely to be more specific to the users' current search, as well as possibly a search engine supported by the embodiments of the present invention which would allow the user to continue to refine their search on the new search engine.

Another embodiment of the present invention would be to modify block 335 in such a way as to allow the user to preview and/or edit the search query before it is submitted to the search engine (block 340). This embodiment of the present invention may be used as a specific option in the program code which the user could turn off or on as desired. The desired setting of this feature may be stored as described in the paragraph which discusses the storing of user preferences.

Another embodiment of the present invention would be to integrate the embodiments of the present invention into the program code of an operating system, web browser, or even in the search engine itself. Any of these integrations would likely remove the need to install a separate plug-in onto the client computer. It should be noted that there may be other places in which the embodiments of the present invention could be integrated to provide the functionality of the embodiments of the present invention. The possible places on the client computer or on the remote server that may be places for integration that have been listed are not intended to be limiting, but to provide a few specific examples of how this embodiment of the present invention may be implemented.

As with any process to assist users in searching the Internet, it may be advantageous to store the preferences of the user on some computer readable medium. A specific example for this alternative embodiment of the present invention would relate to showing the user words or phrases they or possibly even other search engine users have used in a refinement of a previous and similar search query to modify the present search query. Which may be the source of the search query refinement choices presented in element 625 (FIG. 6). User preference data may be stored and managed by the operating system 420, or may be alternately stored and managed by the browser 415 or plug-in 410. Furthermore, the user preference data may be stored remotely, e.g., on a network server, and retrieved by plug-in 410 as necessary.

It will be readily apparent to one skilled in the art that other modifications can be made to embodiments of the present invention, or any combination of the elements of these embodiments without departing from the spirit and scope of the present invention as defined by the appended claims.

### Description of Systems

Referring now to FIG. 1, which illustrates an exemplary computer network 100 upon which embodiments of the present invention may be implemented. Computer network 100 comprises a client computer 105, which is connected to the Internet or other computer network by means of any communication device. The Internet or other computer network 110 is then connected to a search engine 115, or perhaps some other computer network 125 accessible only through the Internet.

Referring now to FIG. 4, which illustrates an exemplary client computer 105 upon which embodiments of the present invention may be implemented. Client computer 105 which is also labeled as 400 comprises memory 405, which holds the computer code for the search query refinement plug-in 410 (embodiments of the present invention), the browser 415, and the operating system 420. The user interacts with user interface 425. The CPU 430 is responsible for executing the computer code in memory. The network interface 435 is the communication means for the client computer 105 to communicate with the Internet or other computer network. Mass storage 440 is typically used for long-term storage of computer code and data.

Referring now to FIG. 7, which illustrates an exemplary computer system 700 upon which embodiments of the present invention may be implemented. Computer system 700 comprises a bus or other communication means 701 for communicating information, and a processing means such as processor 702 coupled with bus 701 for processing information. Computer system 700 further comprises a random access memory (RAM) or other dynamically-generated storage device 704 (referred to as main memory), coupled to bus 701 for storing information and instructions to be executed by processor 702. Main memory 704 also may be used for storing temporary variables or other immediate information during execution of instructions by processor 702. Computer system 700 also comprises a read only memory (ROM) and/or other static storage device 706 coupled to bus 701 for storing static information and instructions for processor 702.

A data storage device 707 such as a magnetic disk or optical disk and its corresponding drive may also be coupled to computer system 700 for storing information and instructions. Computer system 700 can also be coupled via bus 701 to a display device 721, such as a cathode ray tube (CRT) or Liquid Crystal Display (LCD), for displaying information to an end user. Typically, an alphanumeric input device (keyboard) 722, including alphanumeric and other keys, may be coupled to bus 701 for communicating information and/or command selections to processor 702. Another type of user input device is cursor control 723, such as a mouse, a trackball, or cursor direction keys for communicating direction information and command selections to processor 702 and for controlling cursor movement on display 721.

A communication device 725 is also coupled to bus 701. The communication device 725 may include a modem, a network interface card, or other well-known interface devices, such as those used for coupling to Ethernet, token ring, or other types of physical attachment for purposes of providing a communication link to support a local or wide area network, for example. In this manner, the computer system 700 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 700 will vary from implementation to implementation depending upon numerous factors, such as price constraints, performance requirements, technological improvements, and/or other circumstances.

It should be noted that, while the operations described herein may be performed under the control of a programmed processor, such as processor 702, in alternative embodiments of the present invention, the operations may be fully or partially implemented by any programmable or hard coded logic, such as Field Programmable Gate Arrays (FPGAs), TTL logic, or Application Specific Integrated Circuits (ASICs), for example. Additionally, the methods of the embodiments of the present invention may be performed by any combination of programmed general-purpose computer components and/or custom hardware components. Therefore, nothing disclosed herein should be construed as limiting the embodiments of the present invention to a particular embodiment of the present invention wherein the recited operations are performed by a specific combination of hardware components.

### Description of Methods

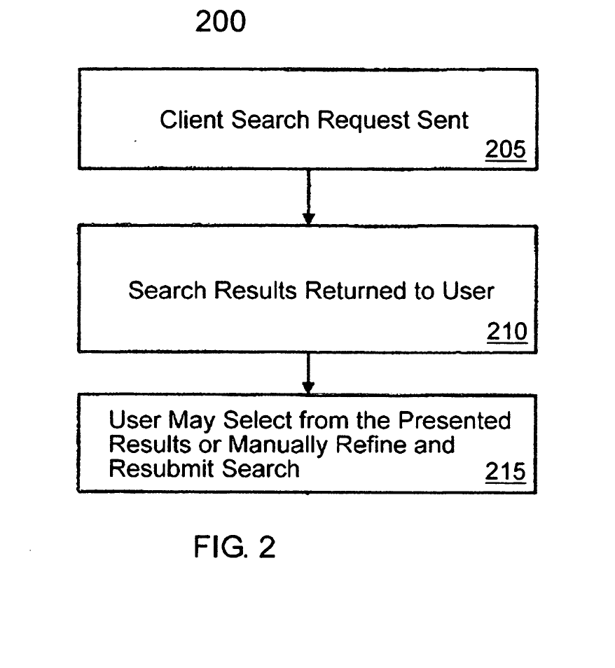

Referring now to FIG. 2, there is shown a flow chart 200 of a method for a user to search the internet. In the first block 205, the user enters a search query into their preferred search engine and then sends this request to the search engine. In the second block 210, the search engine returns a set of search results to the user. In the third block 215, the user may then select from the returned results or manually refine and resubmit their search.

Referring now to FIG. 3, there is shown a flow chart 300 of a method for a user to search the internet utilizing an embodiment of the present invention. In the first block 305, the search engine query construction code is placed into the client computer memory. In the second block 310, the program code (embodiments of the present invention) is loaded (or commonly described as injected) into the search engine page. In the third block 315, the program code waits for user to select a word or a phrase. In the fourth block 320, the program code decides if the user has made a selection it should act upon. In the fifth block 325, if the user has made a selection the program code will act upon, then it will display a pop-up window 635 (FIG. 6) near the users' selected word or phrase 610 (FIG. 6). In the sixth block 330, the user then interacts with the pop-up window by selecting graphical elements which specify the users' intent in relation to the selected content. In an alternative embodiment of the present invention these graphical elements will be the symbols “+” 615 (FIG. 6) or “−” 620 (FIG. 6). In the seventh block 335, the program code creates a new search query by appending Boolean logic and the user selection. In the eighth block 340, the embodiments of the present invention submit this newly constructed search query to the search engine automatically to have a new set of search results presented to the user. In element 350, a loop is described where the user may want to repeat this process on the new set of search results by returning to the point in this flowchart where the embodiments of the present invention are waiting for a user selection to act upon, which is block 320. This loop allows the user to repeat this process as many times as desired. In the ninth block 345, this side block is shown to clarify that the process of waiting for the user to make a selection is a continuous one. This clarifies that as long as the user has not made a selection then the embodiments of the present invention will continue to wait until one is made.

Referring now to FIG. 5, there is shown an element 500 which the embodiments of the present invention may incorporate into the user interface to allow the user to select or deselect categories of information which will be used to refine the search query in a similar way as the “+” or “−” symbols may.

As a specific example, if the users' original search query was the word “star” and the user then deselected the general category of “science” then one possible refinement of the search query may be: “star-physics-space-chemistry-astronomy”. As this search query employs standard Boolean logic used by many search engines at the time of the filing of the embodiments of the present invention, it can be explained as follows. The “+” symbols before a word tell the search engine that the user does not desire results related to that particular word. In the specific example here, then results relating to the word star, but without results relating to the words “astronomy” and “space” will be returned. Of course, the search engine will remove results relating to the other terms preceded by the “−” symbol, although in this specific example these other words are likely to have less of an impact on the returned results. It should be noted that many other categories of information could be added to those shown in FIG. 5. It should also be noted that the constructed search queries for these categories of information may be pre-built for the user, or dynamically built for specific users based on past searches and any stored preferences the user may have. As shown in FIG. 5, categories may be separated into sub-categories such as 510 and 515. The category group 515 is used for a more specific purpose of allowing the user to select from somewhat mutually exclusive categories of information. An example of such a group is shown in 515.

Referring now to FIG. 6, which shows an exemplary search engine typically used on the Internet 600, also labeled as 645. The elements of this exemplary search engine are as follows. The search text box 605 is where the user would initially enter their search and this is also where the refined search queries may be shown as well. The user selected content 610 is shown as being highlighted. The pop-up window is also displayed in this figure as content has been selected in this case. It should be noted that the pop-up window 635 may not be present anywhere in the browser window before a user makes a selection. It should be noted that the graphical window may be permanently displayed in the browser window (on the search page or even on the browser itself) and may or may not be moved to accommodate the user. The “+” 615 and “−” 620 symbols are shown which allow the user to specify their intent in relation to the selected content. A list of suggested terms 625 the user may want to select from to refine their search is shown. A graphical element 630 the user can employ to close the pop-up window if the user decides not to use it. Advertisements or additional hyperlinks 640 may be added for the user to select from in addition to the search results returned by the search engine. It should be noted that these additional hyperlinks need not only be text, but may be any content which the user may interact with to take them to another document.

1. A method of refining a search query to a network-based search engine, the method comprising:
viewing the results of a first search query on a display, the first search query comprising one or more terms;
highlighting a term or phrase within the search results on the display; and
selecting an add or subtract icon in a graphical user interface provided on the display to respectively add or subtract the highlighted term or phrase from the first search query and submit a second search query to the search engine.

2. The method of claim 1, wherein the graphical user interface is revealed when the term or phrase is highlighted.

3. The method of claim 1, wherein one or more paid for advertisements are displayed within the graphical user interface, the advertisements being related to the first search query.

4. A method comprising:
processing a search query;
loading a software routine generally contemporaneously with providing results of the search query to one or more output devices;
detecting a first selection of at least one of a character, word, phrase and image from the results;
providing a user interface on the one or more output devices based on said detecting a selection;
detecting a second selection made by way of the user interface;
modifying the search query based on the second selection;
processing the modified search query; and
providing results to the modified search query.

5. The method of claim 4, wherein the processing of the search query comprises transmitting a user input over a network connection to a search engine.

6. The method of claim 4, wherein the software routine comprises a plug-in for a web browser.

7. The method of claim 6, wherein the plug-in is written in javascript.

8. The method of claim 4, further comprising repeating one or more of said operations of detecting, providing, detecting, modifying, processing and providing responsive to third and fourth selections respectively in replace of the first and second selections.

9. The method of claim 4, wherein said detecting a first selection comprises one or more words highlighted by a user on a visual display, the visual display being at least one of the one or more output devices.

10. The method of claim 4 wherein the one or more output devices comprises a visual display.

11. The method of claim 10, wherein the user interface comprises a graphical user interface displayed on the visual display.

12. The method of claim 10 wherein the second selection comprises a user selection of a graphical element in the graphical user interface.

13. The method of claim 4 wherein the method is practiced on one of a computer, an internet communication device and a telephone.

14. The method of claim 4 wherein in said modifying the search query based on the second selection comprises adding the first selection to the search query to create the modified search query responsive to the second selection.

15. The method of claim 4 wherein in said modifying the search query based on the second selection comprises subtracting the first selection to the search query to create the modified search query responsive to the second selection.

16. A system comprising:
an input device;
an output device;
memory;
a processor; and
a storage medium, the storage medium including a processor-executable routine stored thereon, the routine comprising instructions that when executed by the processor cause the processor to, (i) process a search query, (ii) load a software routine generally contemporaneously with providing results of the search query to one or more output devices, (iii) detect a first selection of at least one or a character, word, phrase and image from the results, (iv) provide a user interface on the one or more output devices based on said detecting a selection, (v) detect a second selection made by way of the user interface, (vi) modify the search query based on the second selection, (vii) process the modified search query and (viii) provide results to the modified search query.

17. The system of claim 16, wherein the system comprises a computer.

18. The system of claim 16, wherein the system comprises a wireless communications device.
